(19) United States
(12) Patent Application Publication
(10) Pub. No.: US 2017/0140308 A1
(43) Pub. Date: May 18, 2017

(54) TABULAR PHASE MAPPING FOR CYCLE TIME REPORTING

(71) Applicant: International Business Machines Corporation, Armonk, NY (US)

(72) Inventors: Jose G. Cano Zapata, Heredia (CR); Frank T. Jahn, South Salem, NY (US); Alan Piciacchio, Wappingers Falls, NY (US)

(21) Appl. No.: 14/938,972

(22) Filed: Nov. 12, 2015

(51) Int. Cl. G06Q 10/06

(52) U.S. Cl. CPC G06Q 10/0633; G06Q 10/06313

(57) ABSTRACT

A method, computer program product, and a computer system is provided. A processor receives a workflow, where the workflow includes a plurality of processes. A processor generates an enumerated list corresponding to the plurality of processes of the workflow. A processor maps a plurality of workflow snapshots to a value in the enumerated list. A processor generates a table, where the table comprises rows of a plurality of work requests and columns of the mapped plurality of workflow snapshots. A processor determines one or more open cycle times for open processes of the plurality of work requests. A processor determines one or more closed cycle times for closed processes of the plurality of work requests. A processor displays a report including the table, the one or more open cycle times, and the one or more closed cycle times.

### BACKGROUND OF THE INVENTION

The present invention relates generally to the field of process improvement, and more particularly to monitoring cycle time.

Many manufactures and service providers have various workflows defined in order to accomplish certain tasks, such a workflow to produce a product or provide a service. Each workflow includes various processes, or steps, required to accomplish the task. The time it takes to perform the processes of a workflow greatly impact performance. For example in a manufacturing line for a product various steps need to be performed to create a final product. Raw materials are received and processed. Component parts are made and assembled. The final assembly is finished and packaged for distribution. Any unexpected delay in any of these tasks impacts the overall workflow. As such, monitoring and reporting performance of various workflow processes provide indicators of where to focus attention in order to improve. A report of particular value is cycle time. Cycle time is the amount of time a particular process takes to complete. High cycle times may indicate bottlenecks in the overall workflow and serve as candidates for process improvement.

### SUMMARY

Embodiments of the present invention provide a method, system, and program product to provide process improvement. A processor generates an enumerated list corresponding to the plurality of processes of the workflow. A processor maps a plurality of workflow snapshots to a value in the enumerated list. A processor generates a table, where the table comprises rows of a plurality of work requests and columns of the mapped plurality of workflow snapshots. A processor determines one or more open cycle times for open processes of the plurality of work requests. A processor determines one or more closed cycle times for closed processes of the plurality of work requests. A processor displays a report including the table, the one or more open cycle times, and the one or more closed cycle times.

### BRIEF DESCRIPTION OF THE SEVERAL VIEWS OF THE DRAWINGS

FIG. 1 is a functional block diagram illustrating a networked environment, in accordance with an exemplary embodiment of the present invention.

FIG. 2 illustrates operational processes of a reporting program, on a computing device within the environment of FIG. 1, in accordance with an exemplary embodiment of the present invention.

FIG. 3A illustrates an example enumerated list of mappings for a workflow.

FIG. 3B illustrates an example table to determine cycle time.

FIG. 3C illustrates an example cycle time report.

FIG. 4 depicts a block diagram of components of the computing device executing a reporting program, in accordance with an exemplary embodiment of the present invention.

### DETAILED DESCRIPTION

While solutions to generating cycle time reports are known, they typically require complex programming solutions to interpret and analyze historical process reports. Process reports may have various time stamps to indicate when a particular process was initiated and the subsequently finished. However, programming solutions must be tailored to each user to interpret the timestamps, such as “Can work be performed on holidays?” and “What shifts can perform the process?”. Each gap in time must be accounted for to properly attribute time worked on the process. Furthermore, previous solutions, require additional programming efforts to account for special cases, such as a client requesting a hold on the workflow and stopping the process.

Embodiments of the present invention recognize that by generating an enumerated mapping of steps in a workflow that a robust data set can be determined with a reduced number of programming considerations. In some known solutions, cycle time reports are generated based solely on timestamp reports of progress in a workflow. In such solutions, when a task is started and subsequently finished, a timestamp for both beginning and ending the tasks is entered. However, such a data can often be cumbersome to handle. For example, a task starts on 8:00 AM Friday and ends 2:00 PM on the following Monday. In such a scenario, the known solution would require complex programming to account for time when the task was not being performed (e.g., nights and weekends).

As discussed herein, embodiments of the present invention categorize timestamp data into snapshots that represent time worked on tasks. By excluding certain snapshots, the embodiments of the present invention discount time not worked on a task from the cycle time attributed to a task. Furthermore, the discrete intervals of snapshots provide basic units that can be manipulated and tallied such that embodiments can determine a cycle time for multiple instances of a workflow in a more efficient manner. Such an increase in efficiency can result from a decreased consumption of one or both of resources and time to determine cycle time for multiple instances of a workflow. As such, embodiments of the present invention provide flexible solutions to handle big data sets of workflow data, particularly large historic data sets that under previous solutions would require additional concerns and testing to ensure correct reporting. Furthermore, embodiments of the present invention provide a direct distinction between closed processes and open processes, allowing for reports to provide information of ongoing processes such that a stakeholder can address current problems in a workflow, while provided historic analysis of closed processes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

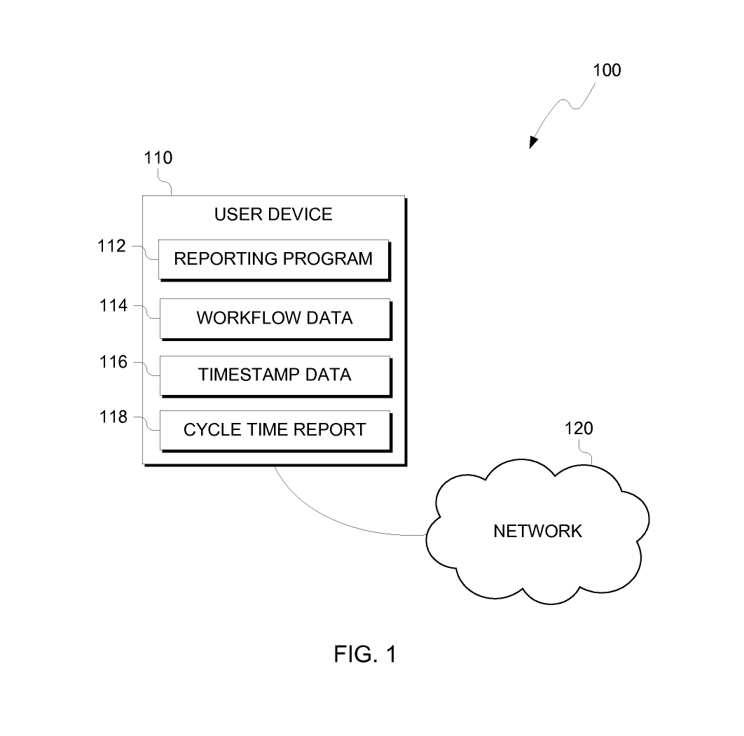

The present invention will now be described in detail with reference to the Figures. FIG. 1 is a functional block diagram illustrating networked environment, generally designated 100, in accordance with one embodiment of the present invention. Networked environment 100 includes user device 110 connected to network 120. User device includes reporting program 112, workflow data 114, timestamp data 116, and cycle time report 118.

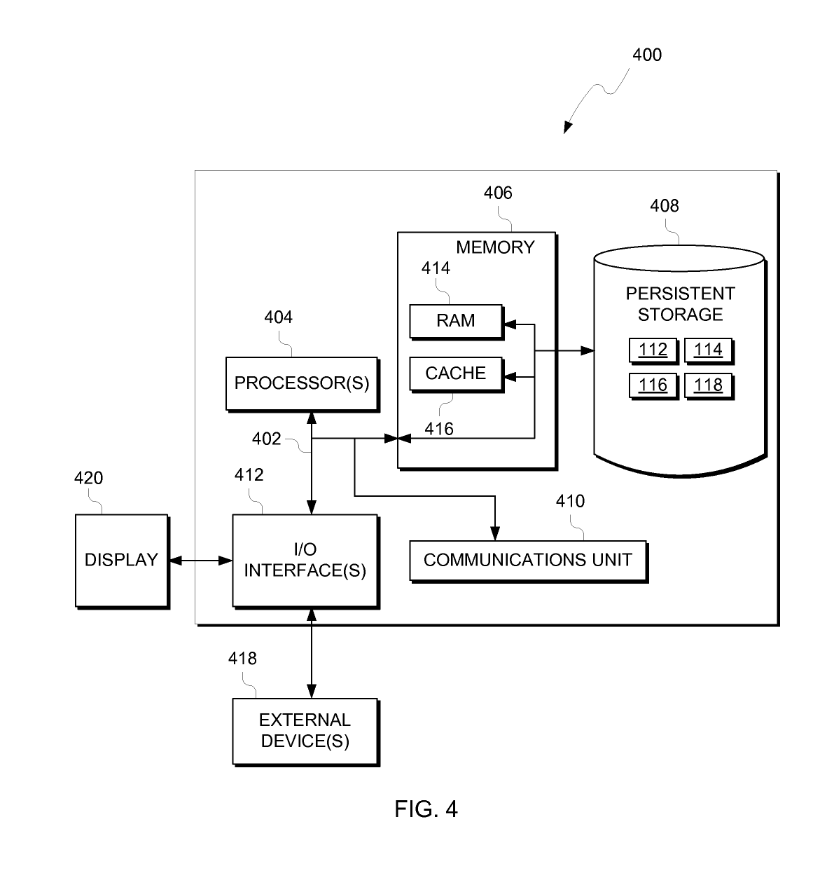

In various embodiments of the present invention, user device 110 is a computing device that can be a standalone device, a server, a laptop computer, a tablet computer, a netbook computer, a personal computer (PC), or a desktop computer. In another embodiment, user device 110 represents a computing system utilizing clustered computers and components to act as a single pool of seamless resources. In general, user device 110 can be any computing device or a combination of devices with access to workflow data 114 timestamp data 116, and cycle time report 118 and is capable of executing reporting program 112. User device 110 may include internal and external hardware components, as depicted and described in further detail with respect to FIG. 4.

In this exemplary embodiment, reporting program 112, workflow data 114, timestamp data 116, and cycle time report 118 are stored on user device 110. However, in other embodiments, reporting program 112, workflow data 114, timestamp data 116, and cycle time report 118 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between user device 110 and other devices (not shown), in accordance with a desired embodiment of the present invention.

In various embodiments, reporting program 112 analyzes workflow data 114 and timestamp data 116 to generate cycle time report 118. Workflow data 114 includes various tasks, and dependency of tasks, to accomplish a goal. Workflows are defined to create a product, perform a service, carry out a project, and the like. Each workflow includes tasks (e.g., steps or processes) to be performed to accomplish the workflow's goal. For example, a workflow to create a piece of furniture is stored in workflow data 114. The workflow includes a description for each task such as prepping raw materials, assembling the prepared parts, or finishing the assembled product. In some embodiments, a task may include multiple sub-tasks. For example, finishing the assembled furniture may include tasks to attach cushioning to the assembled product and to also cover in fabric.

In various embodiments, workflow data 114 includes the dependency of tasks in a workflow. Some tasks, such as the assembly of prepared parts, cannot be performed until a preceding task is complete. As such, a workflow in workflow data 114 also includes a dependency of tasks in the workflow. As used herein, tasks that are performed before a particular task are considered predecessor or parent tasks to that particular task. Likewise, tasks that are performed after that particular task are considered successor tasks or child tasks to that particular task. One of ordinary skill in the art will appreciate that a workflow in workflow data 114 may be representing using any known model or representation without deviating from the invention, given the model includes tasks of the workflow and a dependency between the tasks. Example models include, but are not limited to flowcharts, activity diagrams, directed graph, state diagram, network diagram, program evaluation and review technique (PERT) chart, Gantt chart, and the like. In some embodiments, workflow data 114 includes predicted or average times of each task. For a given task, workflow data 114 may include the amount of predicted time a task should take. Similarly, in some embodiments, workflow data 114 includes historic data that can used by reporting program 112 to determine an average of time previous executions of similar tasks took to complete.

In various embodiments, timestamp data 116 includes time reports regarding specific instances of each performed workflow. For example, a manufacturer tracks each product being produced and an instance of the workflow tracks each product throughout the tasks in the workflow associated with the product. As another example, a service company receives request from clients, with the request corresponding to a workflow to perform the request. Each received request is an instance of a workflow. In various embodiments, timestamp data 116 includes a unique identifier for each instance of a workflow (e.g., a serial number for a product or a work order number for a client request). For each instance of a workflow, the tasks performed are tracked including a start and finish timestamp for tasks in the workflow. In some embodiments and scenarios, timestamp data 116 indicates any actions or scenarios where work has been on hold or ceased, such as a hold request from a client or a cancellation of an order. In some embodiments, timestamp data 116 includes information indicating the employees, group or department that is currently performing or previously performed tasks in a workflow instance. As one of ordinary skill will appreciate, embodiments of the present invention are not directed towards scheduling activities for people, i.e., individuals. A skilled individual will acknowledge that timestamp data 116 and the generated cycle time report 118, as discussed herein, are to provide metrics of past performance, i.e., activities that have already been completed.

In various embodiments, reporting program 112 determines a list of phases for a workflow in workflow data 114. Phases are tasks or groups tasks in a workflow. For example, the assembly phase includes all tasks associated with assembling a product. In some scenarios, a phase includes a single task. In other scenarios, a phase includes multiple tasks. For example, in one embodiment and scenario, concurrent tasks (e.g., tasks that can be simultaneously and independently completed from one another during a period of time) may be grouped into a single phase. Similarly, in one embodiment, a group of sequential tasks (e.g., tasks that are completed one after another) are grouped together into a phase.

In various embodiments, based on the tasks' dependency in a workflow, reporting program 112 groups tasks into a phase. For example, reporting program 112 groups a successor task and predecessor task into a phase due to the tasks' proximity in a workflow. As such, the workflow of predecessor and successor tasks is maintained while grouping similar or less impactful tasks. In some embodiments, based on the tasks' descriptions in a workflow, reporting program 112 determine the phases for a workflow. For example, reporting program 112 groups tasks with descriptions of “Testing—Peak Load” and “Testing—Low Load” into the same phase. In some embodiments, based on the predicted time for completion for tasks, reporting program 112 groups tasks with smaller average predicted completion times for a workflow. For example, reporting program 112 determines an average completion time for all tasks in a workflow. If a total completion for a group of tasks is less than the average time for tasks in a workflow, then reporting program 112 groups the task into a phase (e.g., average completion time for tasks in a workflow is one week and two tasks are predicted to be completed in two days, the reporting program 112 groups the two tasks into one phase). In some embodiments, reporting program 112 presents the phases and the grouped tasks to a user. In some scenarios and embodiments, a user selects or otherwise indicates changes to phase groupings, such as grouping or ungrouping tasks into phases. In some scenarios and embodiments, a user provides one or more phase grouping of tasks to reporting program 112. In some embodiments, reporting program 112 includes a pre-determined phase grouping created by an administrator or designer of reporting program 112.

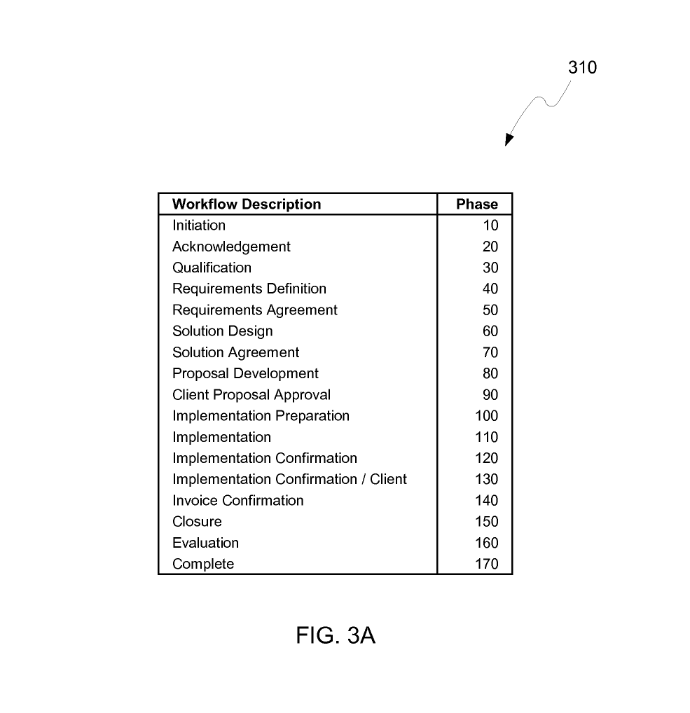

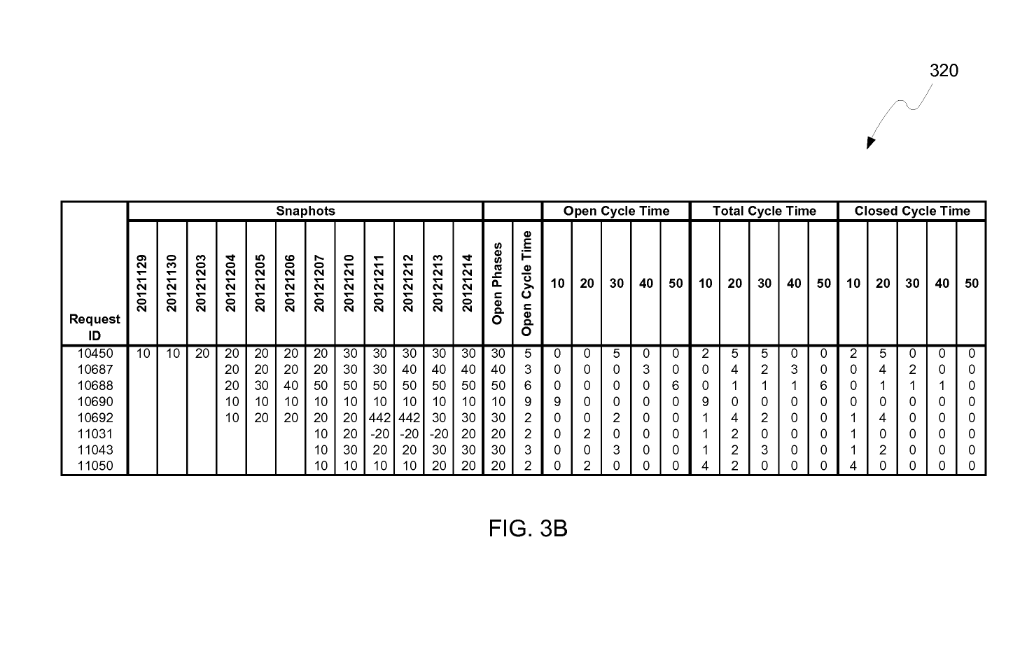

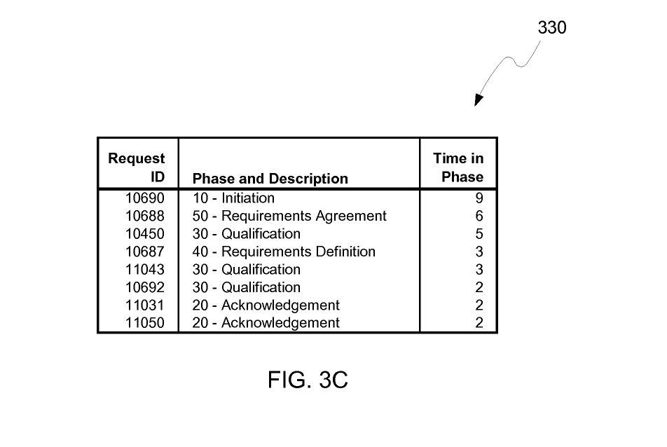

In various embodiments, reporting program 112 generates an enumerated list of phases. For each phase, reporting program 112 assigns a value. Reporting program 112 assigns a smaller value for earlier phases. Reporting program 112 assigns a larger value for later phases. For example, reporting program 112 generates for a phase grouping of “Project Initiation”, “Requirements”, “Design”, “Implementation”, “Testing”, and “Deployment” for a software development workflow, where the phases follow in sequential order. In this example, each of the phases includes component tasks, such as “Testing” having both “Internal Testing” and “User Testing” tasks. To represent the sequential order of the phases, reporting program 112 assigns the following example enumerated list, (10, 20, 30, 40, 50, 60), to the respective phases. As discussed herein, and in reference to FIG. 3A, phase mapping 310 provides an illustrative example of an enumerated list mapped to tasks in a workflow. One of ordinary skill in the art will appreciate that any enumerated list may be used when assigning values to phases, given that the values maintain the sequence of the phases. For example, a descending order list, (60, 50, 40, 30, 20, 10), may be used.

In some embodiments, reporting program 112 generates an enumerated list of values with spacing between values such as in the example above. Doing so provides the advantage of adjusting to new workflow changes made by a user. If new intermediary tasks (e.g., new phase 35) are needed in a workflow, reporting program 112 can maintain the previous values (e.g., 60, 50, 40, 30, 20, 10), while accounting for the new tasks with no changes required in programming when generating cycle time report 118. Furthermore, comparisons to historic reports can still me made since the values for the previously existing phases remain the same.

In various embodiments, reporting program 112 determines a snapshot interval. Based on the workflow and the predicted completion of tasks of the workflow, reporting program 112 selects a snapshot interval that captures a measurement of the predicted completion. For example, a workflow includes three tasks that are predicted to be completed in two, four and six days. Reporting program 112 selects a snapshot interval that is a basic unit of the predicted completion time (e.g., one day). As another example, a workflow includes three tasks with predicted completion times of fourteen days, twenty-one days, and twenty-eight days. Reporting program 112 selects a snapshot interval of one week since the predicted times of the tasks can be divided into weekly intervals. One of ordinary skill will appreciate that any interval may be selected based on the predicted completion times of tasks in a workflow (e.g., hourly, weekly, bi-weekly, monthly, quarterly, or yearly) without deviating from the invention. In some scenarios, reporting program 112 receives from a user a snapshot interval for a particular workflow. In other scenarios, reporting program receives edits to the determined snapshot interval. In some embodiments, if more than one task is grouped in a phase, then reporting program 112 combines the predicted completion times for the tasks in a phase to determined an predicted completion time for the phase.

In various embodiments, reporting program 112 creates a series of snapshots based on the snapshot interval. Each snapshot represents a point in time. As discussed herein, the phase for each instance of a workflow (e.g., a product being made or a work request being performed) is mapped to a snapshot to generate a cycle time report. In some embodiments and scenarios, reporting program 112 excludes one or more snapshots from the cycle time report. For example, a cycle time report with a daily snapshot interval excludes snapshots on weekends for a workflow that only is performed during weekdays. As another example, for a cycle time report with hourly snapshot intervals, certain hours in a day are excluded from the report (e.g., lunch hour, non-working hours, etc.). In some embodiments and scenarios, workflow data 114 includes a schedule of times when a task in a workflow is performed. If a snapshot includes a period of time that is not within by the indicated time of the workflow, then reporting program 112 excludes the snapshot from the report. In other embodiments and scenarios, reporting program 112 receives from the user indicating snapshots or periods of times (e.g., specific days, such as weekends or holidays, or hours, such hours for a particular shift) to exclude from the report.

In various embodiments, reporting program 112 generates a table with instances of workflows referenced by snapshots, with the phase of the instanced workflow for the snapshot as the value of the table. Cycle time table 320 of FIG. 3B illustrates an example data table. Each row or record of the table is for an instanced workflow (e.g., Request IDs 10450 and 10687 represent separate work orders following a similar workflow). Initially, the columns of cycle time table 320 respectively include the previously determined snapshot. Any excluded snapshots are omitted from the table. As such, the snapshots of the table categorize timestamp data 116 into phases. For each snapshot, reporting program 112 determines the phase of the workflow a particular instance was at during the period represented by the snapshot. Advantageously, reporting program 112 no longer requires timestamp data 116 after determining an instances phase value for each snapshot. Furthermore, the phase values for snapshots can be counted for each instance for determine the cycle times for a workflow instance. Therefore, and as discussed herein, Reporting program 112 is configured to determine a cycle time without referring back to timestamp data 116. In some scenarios and embodiments, such calculations are more computationally intensive than a summation or counting of phase values among the snapshots.

In example cycle time table 320, snapshots are generated on a daily interval and represented in a “yyyymmdd” format, where “yyyy” represents the year, “mm” represents the month, and “dd” represents the day. Furthermore, in this example, workflow data 114 indicates the tasks of the workflow are only performed on weekdays. As such, reporting program 112 excludes weekends from the table (i.e., 20121201 and 20121202). For the values of table in the snapshot portion, reporting program 112 retrieves snapshot data 116 for each workflow instance. For each interval, reporting program 112 determines the corresponding phase in the workflow the instance was at during the interval. Reporting program 112 assigns the value based on the enumerated list value associated with the phase. In the example of cycle time table 320 for workflow instance “Request ID 10688” (shown in FIG. 3B), the request was in phase 20 on December 4 and phase 30 on December 5. Based on the task description in timestamp data 116, reporting program 112 assigns the phase value from the enumerated list in phase mapping 310 (i.e., a timestamp indicates on December 4 the request was in the Acknowledgement Phase and assigns 20 to the table for the corresponding row and column).

In some embodiments and scenarios, reporting program 112 assigns values to the table other than phase mapping from the enumerated list (e.g., phase mapping 310). In some scenarios and embodiments, timestamp data 116 includes special indicators such as, but are not limited to, hold orders, withdrawals, cancellations, deletions, or any other indicator that work has paused or ceased on a request or product. In some such scenarios, reporting program 112 assigns certain values outside the range of phase values in the enumerated list. Referring to FIG. 3B, cycle time table 320 illustrates two special indicators for the records of Request ID 10692 and 11031. In this illustrative example, reporting program 112 assigns a value of “442” for two snapshots of Request ID 10692 due to timestamp data 116 indicating a pending withdrawal request. Additionally, reporting program 112 assigns a value of “−20” for three snapshots of Request ID 10692 due to timestamp data 116 indicating that the request was put on hold during the phase associated with “20”. As discussed herein, by using numbers outside the enumerated range of phases for special indicators, reporting program 112 does not include such situations or scenarios when determining cycle time for workflow instances. However, the indicators are still included in the cycle time table 320 for inspection. By using visually distinct values, such as very large numbers outside the enumerated range (e.g., 442, 999, etc.) special cases are identifiable in a workflow instance when cycle time table 320 is reviewed. Similarly, by using a special character to precede or succeed an enumerated phase value (e.g., -, *, etc.), special cases relating to specific phases in a workflow are identifiable, such as hold orders and the phase in which the workflow instance is being held.

In various embodiments, reporting program 112 determines open cycle times for each workflow instance. An open cycle time is the number of snapshots a workflow instance has been at the current phase when the reporting program generates cycle time table 320. In the example illustrated by cycle time table 320, reporting program 112 generates cycle time table 320 sometime during or shortly after a time (e.g., the following snapshot) indicated by the last snapshot. Open cycle time is based on the number of snapshots the last phase value has been assigned to all snapshots for the workflow instance (e.g., row) of cycle time table 320. For example in the row for Request ID 10688, the last snapshot in the table is for 20121214 with a phase of 50. Reporting program 112 determines the number of snapshots with the value of 50 to determine the open cycle time (i.e., 6). Since the snapshot interval is daily, the open cycle time is six days. In some embodiments and scenarios, reporting program 112 appends to the cycle time table 320 an open cycle time portion where the open cycle time is displayed for each phase for the each workflow instance.

In various embodiments, reporting program 112 determines a total cycle time for each workflow instance. As such, a total cycle time is the number of snapshots each phase of a workflow instance is recorded in timestamp data 116. Reporting program 112 tallies each value in the snapshots portion of cycle time table 320. For example in Request ID 10450 of cycle time table 320, reporting program 112 determines that the request was in phase ‘10’ for two snapshots (i.e., two days). In some embodiments and scenarios, reporting program 112 appends to the cycle time table 320 a total cycle time portion where the total cycle time is displayed for each phase for the each workflow instance.

In various embodiments, reporting program determines a closed cycle time for each workflow instance. A closed cycle time is applied to phases in a workflow that have been completed. For example, looking at Request ID 10687 of cycle time table 320, this particular workflow instance has completed phases 20 and 30 and currently performing phase 40. As such, reporting program 112 includes phases 20 and 30 closed cycle time calculations and reports and, as discussed herein, 40 open cycle time calculations and reports. In some embodiments and scenarios, based on the determined total cycles time values and open cycle time values, reporting program 112 determines closed cycle time values by subtracting the corresponding values in each portion of the table, respectively. For example, in Request ID 10450 and for Phase 10 in closed time determination, reporting program 112 subtracts the open cycle time in phase 10, ‘0’, from the total cycle time for phase 10, ‘2’, to determine the closed cycle time of two snapshots.

As such, reporting program 112 removes the open cycles from the total cycle time to determine the closed cycle times for phases in a workflow instance that have been closed or completed. By arranging and calculating cycle times in a table format with basic operations, (i.e., summations of phases to determine open and total cycle times then matrix subtractions of total and open cycle time reports to determine closed cycle time) embodiments of the present invention provide the advantage of determining cycle time reports in a reduced period of time, specifically for large data sets. In some embodiments, reporting program 112 is a productivity software application and cycle time table 320 is a spreadsheet or similar interactive table. In other embodiments, reporting program 112 is a standalone application programmed to produce cycle time table 320. In some scenarios and embodiments, reporting program 112 produces a file to export cycle time table 320 to be imported into another software application for viewing.

In some embodiments, reporting program 112 generates additional reports based on information generated in the snapshots, the open cycle times, the total cycle times, or the closed cycle times. For example, reporting program 112 generates a report of open cycle times sorted based on the highest open cycle time. Referring to open cycle time report 330, reporting program 112 generates a sorted table with the workflow instance with open cycle time displayed in a descending order. In some embodiments, reporting program 112 retrieves workflow descriptions for phase mapping 310 to provide a readable description of the phases the workflow instance is currently at in a workflow. One of ordinary skill in the art will appreciate that any report can be generated by reporting program 112 using the information generated in the snapshots, the open cycle times, the total cycle times, or the closed cycle times of cycle time table 320 without deviating from the invention. Furthermore, in some scenarios and embodiments, such as in a productivity application, reporting program 112 formats cycle time table 320 to indicate certain conditions or scenarios. For instance, if a workflow instance is currently on hold, then reporting program 112 formats the row of the workflow instance to indicate the hold (e.g., the color of the row changes). Cycle time report 118 can include, but is not limited to tables and reports such as phase mapping 310, cycle time table 320, open cycle time report 330, or any other report or table including the snapshots, the open cycle times, the total cycle times, or the closed cycle times.

In some scenarios and embodiments, reporting program 112 determines a rework condition in the cycle time table 320. Reworks occur when, later in a workflow, a product or request is directed back to previous workflow tasks. For example, after some testing, a software module in for a particular client request does not meet requirements of the client. As such, the request is sent back for a rework to fix the failures noticed in testing. Previous solutions would require additional programming to account for such scenarios. In various embodiments, reporting program 112 determines rework scenarios in a workflow instance by comparing the sequential phases among snapshots. For example and referring to Request ID 11043 of cycle time table 320, reporting program 112 compares a previous column to the current columns value. In some embodiments, if a previous column's phase value is greater than the current columns, then reporting program 112 determines a rework condition has occurred for the workflow instance. In this example, the phase sequence reflects phases “10, 30, 20, 20, 30 . . . ”. As reporting program 112 steps through a phase sequence for the request, reporting program 112 determines that on the snapshot 20121210, the request entered a rework since the previous snapshot had a phase value greater the current phase value, indicating the workflow instance reverted to a previous phases and, as such, was a rework. As discussed herein, in some embodiments, reporting program 112 is configured to generate a report or format cycle time table 320 to indicate when rework situations occur. For example, reporting program 112 generates a report including Request IDs where a rework occurred, the snapshots the rework occurred, or how long a Request ID spent in rework.

In some scenarios and embodiments, reporting program 112 generates a throughput report based on phase values for snapshots of cycle time table 320. A throughput report includes the current status of workflow instances at a given point in time. For example and referring to cycle time table 320, reporting program 112 generates a throughput report indicating how many Request IDs are past phase 20 at the runtime (e.g., the current date) of the report. In this example, five request IDs (i.e., 10450, 10687, 10688, 10692, 11043) are currently in phases past phase 20. Such reports are useful to track overall progress of groups of requests (e.g., a batch of products that started production at or near the same time). Additionally, such reports allow users to track throughput for batches of similar workflow instances to determine overall throughput of a stakeholder or organization.

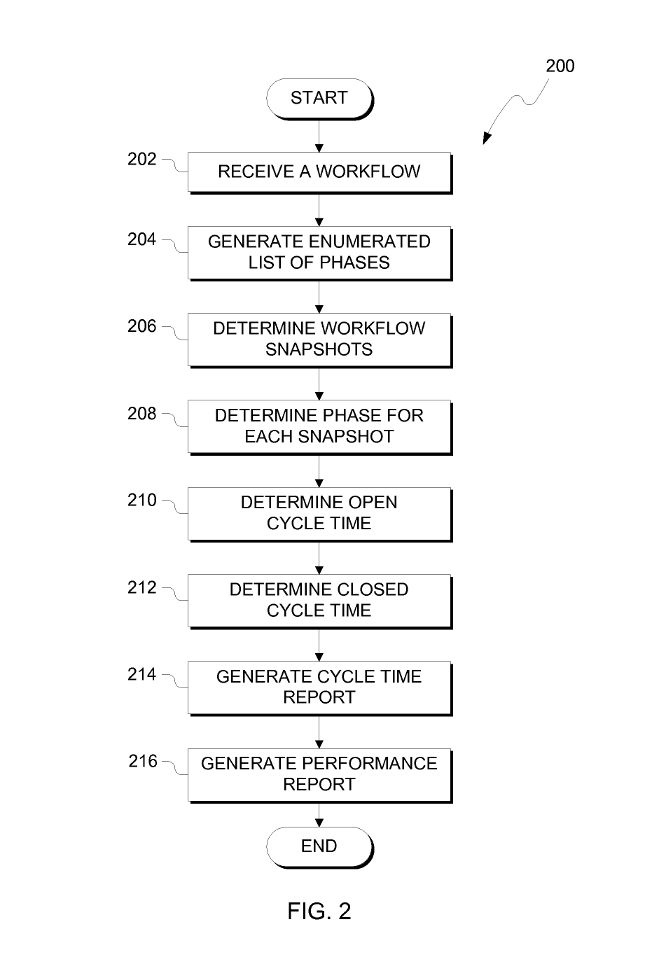

FIG. 2 illustrates operational processes, generally designated 200, of reporting program 112. In process 202, reporting program 112 receives a workflow in workflow data 114. The workflow includes various tasks required to be performed to accomplish a goal, such a providing a service or making a product. For example, the workflow includes a flowchart of tasks indicating a dependency of successor and predecessor tasks to arrive at the goal. In process 204, reporting program 112 generates an enumerated list of phases for the workflow in cycle time report 118 (e.g., phase mapping 310). In some scenarios and embodiments, a phase corresponds to a task in the workflow. In some scenarios and embodiments, a phase is a grouping of more than one task. Based on the dependency of tasks, reporting program 112 assigns enumerated values to the phases, with earlier phases in the workflow having lower values than later phases. In some embodiments, reporting program 112 receives an enumerated list of phases from a user. In some embodiments, reporting program 112 receives edits to the enumerated list from a user.

In process 206, reporting program 112 determines the workflow snapshots to include in a cycle time table. Based on predicted completion times of phases or tasks in a workflow, reporting program 112 determines a snapshot interval for the cycle time table. For example, if the predicted time is measured in days, then reporting program 112 selects a daily as the snapshot interval. In some embodiments, reporting program 112 receives a snapshot interval from a user. In various embodiments, based on the snapshot interval and timestamp data 116, reporting program 112 generates a series of workflow snapshots. Based on the earliest timestamp data, reporting program 112 generates a snapshot in cycle time report 118 (e.g., the snapshots portion of cycle time table 320). Based on the snapshot interval, reporting program 112 generates the next snapshot in cycle time report 118 (e.g., a snapshot for the following day). In some scenarios, reporting program 112 continues until the snapshot encompasses the latest time in timestamp data 116 (e.g., the last day of reporting). In other scenarios, reporting program 112 receives a starting or ending date from a user. In response, reporting program 112 generates snapshots based on the received range of time.

In process 208, reporting program 112 determines a phase for each snapshot based on timestamp data 116 of one or more workflow instances. For each snapshot, reporting program 112 determines the phase a workflow instance was at during the snapshot. Reporting program 112 retrieves timestamp data for the workflow instance associated with the snapshot. Based on the indicated task in the workflow, reporting program 112 assigns an enumerated value to the cycle time table according to the phase mapping (e.g., process 204). As such, reporting program 112 generates a table with records of each workflow instance and enumerated phase values that a workflow instance was recorded at during the snapshot as indicated by timestamp data 116.

In process 210, reporting program 112 determines the open cycle time for the workflow instances cycle time report 118. Based on the last timestamps phase, for each workflow instance reporting program 112 counts the number of timestamp interval with the same phase value. Based on the count of columns with the same phase value as the last timestamp, reporting program 112 determines the open cycle time for each workflow instance. In process 212, reporting program 112 determines the total cycle time for all phases in each workflow instances. For each phase value, reporting program 112 counts each snapshot with the same phase values. As such, reporting program 112 determines the total time in snapshot intervals that each workflow instance spent in a given phase. In process 212, reporting program 112 determines the closed cycle times in each phase for the workflow instances. Closed cycle time is the number of snapshot intervals a workflow instance spent in a given phase and the phases is completed. Reporting program 112 subtracts the table generated for open cycle time from the table generated from total cycle time to determine closed cycle time.

In process 214, reporting program 112 provides cycle time report 118 to the user. In some scenarios, one or more of the phase mapping, snapshots, the open cycle times, the total cycle times, or the closed cycle times. In a scenario, reporting program 112 provides sorting or filter functions to a user to view specific portions of cycle time report 118 (e.g., a timestamp or snapshot range, highest cycle times, or workflows with special indicators). In another scenario, reporting program 112 provides conditional formatting to cycle time report 118 in order to bring attention to certain values or situations (e.g., color changes, highlighting, and the like).

In process 216, reporting program 112 generates a performance report based on cycle time report 118. In some scenarios, the performance report includes performance metrics, such as a throughput report of the progress of various workflow instances. For example, reporting program 112 determines the number of workflow instances past or at a certain phase. As another example, reporting program 112 generates a performance report to determine performance metrics. For example, reporting program 112 includes an average phase or task completion time. In some embodiments and scenarios, the performance report includes workflow instances with phases that exceed the average completion time.

In some embodiments and scenarios, reporting program 112 generates a performance report that indicates budgeting, billing, compensation or rewards that correspond to one or both of performance metrics. For example, the performance report may include the number of snapshots to bill a client for work performed by various departments, groups or employees. The client has a service level agreement that indicates an additional penalty fee for each day the product is not delivered past an agreed upon due date. As such, reporting program 112 generates a report showing the bill based on the number of snapshots and discounts that total by a penalty fee, which is zero since the product was delivered by the agreed upon date. In another example, reporting program 112 generates a report showing the performance metrics for a particular department. In this example, the employees receive a bonus if their performance is above a threshold. As such, reporting program 112 determines the amount of bonus for each employee in that department, which corresponds to the amount by which the performance metric of their department has exceeded the threshold for that performance metric. In a third example, reporting program 112 determines a predicted total cost for a project based on the performance report. In one such example, the average phase or time to complete a given task has a known associated, or calculable, cost to a company. As such, reporting program 112 determines the total cost to produce one or more products and uses that data to predict what the total cost will be to produce a total number of products.

In some embodiments, reporting program 112 generates a report indicating specific resources (for example, departments, phases, and task completion times etc.) that are not meeting predetermined thresholds for performance based on determined performance metrics for that resource. In some such embodiments, reporting program 112 is configured to indicate the type and quantity of change needed in order to meet a predetermined level of performance. In some embodiments, reporting program 112 predicts the effects that such a change will have. For example, reporting program 112 determines that the cost to produce ten units of product “A” is ten thousand dollars. Reporting program 112 also determines that the respective performance metrics for departments 1, 2, and 3, which are all producing product A. However, the performance metrics show that department 2 has significantly lower performance metrics when compared to departments 1 and 3. As a result, of the lower performance of department 2, reporting program 112 determines that the cost to produce ten units of product “A” is being increased by seventeen percent. As such, reporting program 112 generates a report showing what the predicted cost of producing a predetermined quantity of product A is overall, as well as what the projected cost would be if department 2 were to have the same performance metrics of departments 1 and 3.

In some embodiments, reporting program 112 is incorporated into a control system for a production process of a product. As such, in some scenarios and embodiments, reporting program 112 manages the production levels of one or more components that are included in the product such that a surplus of any given component is reduced, i.e., is below a threshold. In some such embodiments, the performance metrics for the production of the various components are used, by reporting program 112, to predict the quantity of those components that have been produced, will be produced, or should be produced. In some scenarios and embodiments, using these predicted values, reporting program 112 modifies the productions schedules for the various components such that such that a surplus of any given component is below one or more respective thresholds for those components. In some scenarios and embodiments, the modified schedule includes reducing the number of hours, shifts, etc. that are allocated to producing a particular component. In some scenarios and embodiments, a productions rate or goal is modified by reporting program 112 such that a surplus of a given component is below a threshold for that components.

FIG. 4 depicts a block diagram, 400, of components of user device 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

User device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Reporting program 112, workflow data 114, timestamp data 116, and cycle time report 118 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage X08.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Reporting program 112, workflow data 114, timestamp data 116, and cycle time report 118 may be downloaded to persistent storage 408 through communications unit 410.

I/O interface(s) 412 allows for input and output of data with other devices that may be connected to user device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., reporting program 112, workflow data 114, timestamp data 116, and cycle time report 118, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

1. A method of comprising:
receiving, by one or more processors, a workflow, wherein the workflow includes a plurality of processes;
generating, by the one or more processors, an enumerated list corresponding to the plurality of processes of the workflow, wherein the enumerated list comprises higher values for a successor process in the workflow and lower values for a predecessor process in the workflow;
mapping, by the one or more processors, a plurality of workflow snapshots to a plurality of values in the enumerated list, wherein a first workflow snapshot of the plurality of workflow snapshots is mapped to a first value of the values in the enumerated list;
generating, by the one or more processors, a table, wherein the table comprises rows of a plurality of work requests and columns of the mapped plurality of workflow snapshots;
determining, by the one or more processors, one or more open cycle times for open processes of the plurality of work requests based, at least in part, on a corresponding one or more counts of a last mapped value for at least one row of the rows of the plurality of work requests, wherein the last mapped value corresponds to a value of the plurality of values in the enumerated list;
determining, by the one or more processors, one or more closed cycle times for closed processes of the plurality of work requests based, at least in part, on a corresponding one or more counts of predecessor mapped values to the last mapped value for the at least one row of the rows of the plurality of work requests, wherein the predecessor mapped values are predecessor processes to a process associated with the last mapped value for the at least one row of the rows of the plurality of work requests; and
generating, by the one or more processors, a report including (i) the table, (ii) the one or more open cycle times, and (iii) the one or more closed cycle times.

2. (canceled)

3. (canceled)

4. The method of claim 1, wherein the enumerated list includes one or more unused categories to account for changes to the workflow.

5. The method of claim 1, the method further comprising:
determining, by the one or more processors, a snapshot interval for the plurality of workflow snapshots, wherein the snapshot interval is based, at least in part, on a frequency of the plurality of workflow snapshots.

6. The method of claim 1, wherein the report includes an ordered list of work requests based, at least in part, on a descending value of the one or more open cycle times.

7. The method of claim 1, the method further comprising:
excluding, by the one or more processors, a set of snapshots from the report, wherein the set of snapshots correspond to snapshots taken during one or more of the following: (i) holidays, (ii) non-working days, (iii) non-working hours, (iv) hold requests; and (v) downtime.

8. A computer program product comprising:
one or more computer-readable storage media and program instructions stored on the one or more computer-readable storage media, the program instructions comprising:
program instructions to receive a workflow, wherein the workflow includes a plurality of processes;
program instructions to generate an enumerated list corresponding to the plurality of processes of the workflow, wherein the enumerated list comprises higher values for a successor process in the workflow and lower values for a predecessor process in the workflow;
program instructions to map a plurality of workflow snapshots to a plurality of values in the enumerated list, wherein a first workflow snapshot of the plurality of workflow snapshots is mapped to a first value of the values in the enumerated list;
program instructions to generate a table, wherein the table comprises rows of a plurality of work requests and columns of the mapped plurality of workflow snapshots;
program instructions to determine one or more open cycle times for open processes of the plurality of work requests based, at least in part, on a corresponding one or more counts of a last mapped value for at least one row of the rows of the plurality of work requests, wherein the last mapped value corresponds to a value of the plurality of values in the enumerated list;
program instructions to determine one or more closed cycle times for closed processes of the plurality of work requests based, at least in part, on a corresponding one or more counts of predecessor mapped values to the last mapped value for the at least one row of the rows of the plurality of work requests, wherein the predecessor mapped values are predecessor processes to a process associated with the last mapped value for the at least one row of the rows of the plurality of work requests; and
program instructions to generate a report including (i) the table, (ii) the one or more open cycle times, and (iii) the one or more closed cycle times.

9. (canceled)

10. (canceled)

11. The computer program product of claim 8 wherein the enumerated list includes one or more unused categories to account for changes to the workflow.

12. The computer program product of claim 8, the program instructions further comprising:
program instructions to determine a snapshot interval for the plurality of workflow snapshots, wherein the snapshot interval is based, at least in part, on a frequency of the plurality of workflow snapshots.

13. The computer program product of claim 8, wherein the report includes an ordered list of work requests based, at least in part, on a descending value of the one or more open cycle times.

14. The computer program product of claim 8, the program instructions further comprising:
program instructions to exclude a set of snapshots from the report, wherein the set of snapshots correspond to snapshots taken during one or more of the following: (i) holidays, (ii) non-working days, (iii) non-working hours, (iv) hold requests; and (v) downtime.

15. A computer system comprising:
one or more computer processors;
one or more computer readable storage media; and
program instructions stored on the computer readable storage media for execution by at least one of the one or more processors, the program instructions comprising:
program instructions to receive a workflow, wherein the workflow includes a plurality of processes;
program instructions to generate an enumerated list corresponding to the plurality of processes of the workflow, wherein the enumerated list comprises higher values for a successor process in the workflow and lower values for a predecessor process in the workflow;
program instructions to map a plurality of workflow snapshots to a plurality of values in the enumerated list, wherein a first workflow snapshot of the plurality of workflow snapshots is mapped to a first value of the values in the enumerated list;
program instructions to generate a table, wherein the table comprises rows of a plurality of work requests and columns of the mapped plurality of workflow snapshots;
program instructions to determine one or more open cycle times for open processes of the plurality of work requests based, at least in part, on a corresponding one or more counts of a last mapped value for at least one row of the rows of the plurality of work requests, wherein the last mapped value corresponds to a value of the plurality of values in the enumerated list;
program instructions to determine one or more closed cycle times for closed processes of the plurality of work requests based, at least in part, on a corresponding one or more counts of predecessor mapped values to the last mapped value for the at least one row of the rows of the plurality of work requests, wherein the predecessor mapped values are predecessor processes to a process associated with the last mapped value for the at least one row of the rows of the plurality of work requests; and
program instructions to generate a report including (i) the table, (ii) the one or more open cycle times, and (iii) the one or more closed cycle times.

16. (canceled)

17. (canceled)

18. The computer system of claim 15, wherein the enumerated list includes one or more unused categories to account for changes to the workflow.

19. The computer system of claim 15, the program instructions further comprising:
program instructions to determine a snapshot interval for the plurality of workflow snapshots, wherein the snapshot interval is based, at least in part, on a frequency of the plurality of workflow snapshots.

20. The computer system of claim 15, wherein the report includes an ordered list of work requests based, at least in part, on a descending value of the one or more open cycle times.
